(19) United States
(12) Patent Application Publication
(10) Pub. No.: US 2026/0171945 A1
(43) Pub. Date: Jun. 18, 2026

(54) ANGLE ADAPTION CIRCUIT AND CONTROL SYSTEM

(71) Applicant: VALEO ELECTRIFICATION, Cergy Pontoise (FR)

(72) Inventors: Andreas HELD, Erlangen (DE); Muhamad-Ikhwan BIN-ISMAIL, Erlangen (DE)

(73) Assignee: VALEO ELECTRIFICATION, Cergy Pontoise (FR)

(21) Appl. No.: 19/124,939

(22) PCT Filed: Dec. 19, 2023
(86) PCT No.: PCT/EP2023/086773

§ 371 Date: Apr. 28, 2025

(30) Foreign Application Priority Data
Dec. 21, 2022 (FR) FR2214120

(51) Int. Cl. H02P 23/14; H02P 23/03

(52) U.S. Cl. CPC H02P 23/14; H02P 23/03

(57) ABSTRACT

A control system and angle adaption circuit for shifting an angle used by a control system of an electrical machine. The angle adaption circuit includes at least one input for receiving information of a torque and/or information of a speed of the electrical machine. The angle adaption circuit includes an adaption module connected with the at least one input. The adaption module is configured to process the information received via the at least one input and to output an angle offset to be applied to an angle value of the electrical machine.

The invention relates to an angle adaption circuit for shifting an angle offset used by a control system of an electrical machine. Further, the invention relates to a control system for an electrical machine.

In the state of the art, control systems for an electrical machine are known, which comprise a control system for outputting a voltage set-point based on an operation point for the electrical machine. The control systems typically comprise a current set-point determination module, a current controller and a voltage modulation module. These components of the control system are used to control the duty cycles of (power) switches of an inverter that is coupled with the electrical machine.

These control systems also comprise an angle evaluation module that is configured to determine an actual angle of the electrical machine based on which the control system determines the voltage set-point accordingly.

Typically, the operation point based on which the voltage set-point is determined is optimized based on maximum torque per ampere (MTPA) and maximum torque per flux (MTPF), also called maximum torque per voltage (MTPV). However, it turned out that these operation point optimizations known have disadvantages for low torques and low speed values.

Accordingly, there is a need for an optimized system to be used at low torques and low and medium speed values.

The invention provides an angle adaption circuit for shifting an angle used by a control system of an electrical machine. The angle adaption circuit comprises at least one input for receiving information of a torque and/or information of the speed of the electrical machine. The angle adaption circuit comprises an adaption module connected with the at least one input. The adaption module is configured to process the information received via the at least one input and to output an angle offset to be applied to an angle value of the electrical machine.

The angle offset is used to deviate the angle used to determine the voltage set-point of the electrical machine from the actual position of the rotor of the electrical machine.

Then a shifted angle value corresponding a sum between the angle offset outputted from the angle adaption circuit and an angle value of the electrical machine is used for determining the operation point to calculate the voltage set-point of the electrical machine.

Preferably, the angle value correspond to the position sensor measurement corrected because of mechanical and electrical misalignments.

Further, the invention provides a control system for an electrical machine. The control system comprises a controller, e.g. for outputting a voltage set-point based on an operation point for the electrical machine. The control system also comprises an angle evaluation module configured to determine an angle value of the electrical machine and the angle adaption circuit as described above.

Accordingly, the angle evaluation module determines the angle value of the electrical machine that is adapted by means of the angle offset applied, thereby obtaining a shifted angle value. Actually, the shifted angle value may be obtained by adding the angle offset to the angle value. The shifted angle value is forwarded to the controller that inter alia processes the shifted angle value in order to determine the voltage set-point for the electrical machine.

The angle evaluation module determines the angle value based on a position information from a rotor of the electrical machine. For example, the angle value is determined by measuring the rotor position with a position sensor to which a corrective value is added. The angle value is determined much more precisely and better correspond to the actual position of the rotor thanks to the corrective value, which enables more precise control of the electrical machine. The main idea of the invention is to actively adapt the angle by adding the angle offset, thereby manipulating a current set-point. The voltage set-point may be determined based on the current set-point. Hence, the current set-point is actively manipulated by means of the angle offset adaption, which is processed by the (current) controller of the control system for controlling the electrical machine. In fact, the controller may determine the voltage set-point based on the manipulated current set-point.

In other words, the controller receives the shifted angle (value) and the current set-point. The controller processes the shifted angle as well as the current set-point, thereby determining the voltage set-point that is inter alia used for controlling the inverter, particularly the power switches. Accordingly, the angle offset adaption results in an optimization of the operation point, as the operation point is actively shifted due to the angle offset applied to the angle value determined.

Generally, the angle offset applied to the angle determined may result in an adapted/shifted angle offset. In other words, the angle determined is used to identify an angle offset which is manipulated by the angle offset determined by the angle adaption circuit.

The angle offset is determined based on the information received, namely the information of the torque and/or the information of the speed of the electrical machine, is added to the angle value of the electrical machine that was determined and/or measured previously.

Particularly, the optimization based on the angle offset adaption is used for low torques and low and medium speed values, for instance within a range of +/−500 Nm and/or 0-600 rpm, particularly +/−300 Nm and/or 0-400 rpm or rather 100-400 rpm. It should be understood that this range example are only for purpose of illustration since this range is very dependent on the electrical machine design. These ranges typically relate to a rolling vehicle with friction compensation or light acceleration/breaking, where the electrical machine is still operated with a maximum torque per ampere (MTPA) strategy. In other words, the angle adaption may be limited to low absolute speed and/or low absolute torque values. In fact, a low sensitivity of angle offset to torque accuracy is given in this specific range.

Once the requested torque or the estimated torque leaves the relevant operation range, the angle-offset adaption is ramped to zero. Hence, a sudden jerk due to more torque due to a transition back into the MTPA trajectory is prevented. Further, it also prevents jerk when transition back to MTPV if the torque jumps suddenly close to unity modulation index The resulting torque is reduced due to the shifted angle. However, this reduced torque is not significant in the desired operation point since torque accuracy margin in these low torque operation points are absolute and large compared to other operation points, particularly higher torque operation points. Furthermore, the torque inaccuracy or rather the reduced torque will be compensated by a driver.

Generally, the angle adaption, namely the angle offset applied, shifts the operation point of the current from the MTPA closer to maximum torque per loss MTPL trajectory, thereby increasing the efficiency.

In comparison to a MTPL implementation, the dependencies are reduced, thereby reducing the overall computational power required.

In fact, the angle adaption circuit as well as the control system is suitable for being implemented in an automotive embedded system.

Accordingly, a simplified online angle adaption is obtained that is used to manipulate the set-point of the controller in order to maximize the efficiency of the entire system. Particularly, the angle adaption circuit as well as the control system overcome an efficiency gap in low speed/torque operation points that are used frequently during standard driving cycles.

The at least one input may relate to an interface, e.g. a data interface, via which the respective data/information is obtained and processed.

In general, the inverter is operated based on the current set-points and the voltage set-points which define the controlling of the inverter.

An aspect provides that the at least one input is further configured to receive information of a DC-link voltage and/or information of a temperature of the electrical machine. For instance, the temperature of a permanent magnet of the electrical machine is received via the at least one input. The respective temperature may be measured or rather estimated, e.g. by an observer.

Accordingly, the angle offset is determined based on different kinds of information, namely information of the torque, information of the speed of the electrical machine, information of the DC-voltage and/or information of the temperature of the electrical machine. These different kinds of information are processed by the angle adaption circuit in order to determine the angle offset to be applied. Therefore, the angle offset to be applied can be determined more accurately, as different types of information are processed and considered accordingly. For instance, a temperature-dependent adaption takes place by also considering the information of the temperature of the electrical machine, as iron losses (eddy current and hysteresis losses) depend on the temperature of the electrical machine.

Generally, the angle offset adaption, namely applying the angle offset, results in a manipulation of the current set-point processed by the controller, which is leading to a reduction of iron losses.

A further aspect provides that the information of the torque corresponds to an estimated actual torque and/or an input torque set-point. In other words, the information of the torque may relate to a requested torque (torque set-point) or rather an actual torque estimated by a torque observer. The angle adaption circuit may receive both the estimated actual torque and the input torque set-point.

Another aspect provides that the adaption module comprises a look-up table (LUT) that links the information received via the at least one input with the angle offset. Accordingly, the look-up table ensures that the angle offset can be determined in an easy and simple manner, as the information received is checked with entries of the look-up table in order to determine the corresponding angle offset to be applied. Put differently, the look-up table comprises information associated with operation points, e.g. torque and/or speed, and corresponding angle offsets.

In addition, a linear interpolation may take place between operation points such that an angle offset can be determined even though the look-up table does not comprise an angle offset entry for a certain constellation.

The look-up table (and the interpolation technique) ensures that computational capacities can be minimized such that an implementation of the angle adaption circuit is simple. In fact, it requires low processing and memory capacities. Moreover, memory consumption is reduced overall.

The adaption module may comprise a filter module that is configured to filter a pre-adapted angle offset, thereby obtaining the angle offset. The filter module may avoid sudden jumps within the shifted angle. For filtering the pre-adapted angle offset, the filter module may apply a filter function. The filter function may take the previous angle offset into account. This ensures a smooth transition of the angle offset, thereby avoiding current peaks that might occur if the shifted angle would jump. The filter function may also take the temperature of the electrical machine and/or the DC-link voltage into account, particularly all kinds of information inputted via the at least one input.

Further, the angle adaption circuit may be an add-on circuit that is configured to be implemented into a control system for the electrical machine. Thus, the angle adaption circuit has an interface that can be connected with an already existing control system such that the already existing control system is extended by the angle adaption circuit. Thus, a functionality with regard to the angle offset adaption is added to the already existing control system. The functionalities of an already existing control system for the electrical machine can be extended due to the add-on circuit.

An aspect provides that the angle evaluation module and the angle adaption circuit are connected with each other in a node that is configured to process the angle value determined by means of the angle evaluation module and the angle offset outputted by means of the angle adaption circuit, thereby determining a shifted angle. The respective angle (value) is adapted such that the shifted angle value is obtained that is forwarded to the controller. In fact, an already existing offset may be altered due to the angle offset determined and applied to the angle.

Particularly, the node is connected to the controller such that the controller is configured to receive the shifted angle value, thereby shifting the operation point for the electrical machine. The operation point is actively shifted based on the angle offset determined by the angle adaption circuit. As discussed above, the angle offset is determined based on different kinds of information.

The angle evaluation module may be an angle sensor configured to measure an actual angle of the electrical machine or an angle observer configured to estimate an actual angle of the electrical machine. Therefore, the respective angle value that is adapted by the angle offset outputted by the angle adaption circuit may be measured or estimated. This depends on the respective type of angle evaluation module.

Generally, the control system, particularly the current controller and the modules for set-point determination, remains operating with the known method of applying the smallest amount of current to generate the desired torque, namely MPTA.

The angle adaption circuit observes an input torque set point, an actual torque and/or an electrical machine speed. Optionally, an electrical machine permanent magnet temperature and/or a DC-link voltage is also observed by the angle adaption circuit.

Based on the observed parameters, the look-up table is accessed, namely by the adaption module, to generate the angle offset that is added to the angle value determined, namely measured or rather estimated. Hence, an angle offset adaption takes place.

The adaption module may generate the angle offset by interpolating angle offsets stored in the look-up table. In fact, this depends on the operational point associated with the observed parameters.

Further aspects and advantages of the claimed subject matter will become more readily appreciated as the same became better understood by reference to the following description when taken in conjunction with the accompanying drawings. In the drawings,

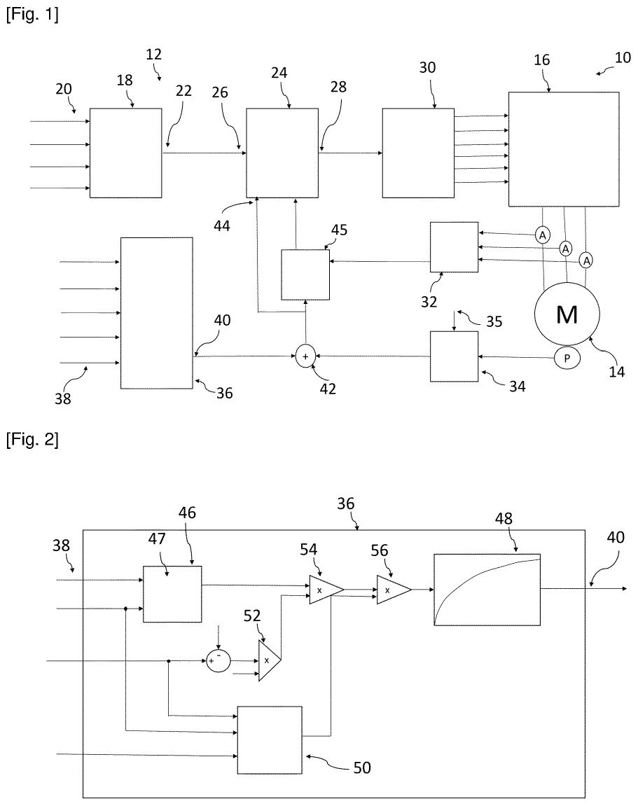

FIG. 1 shows an overview of a control system according to the invention, and

FIG. 2 shows an overview of an angle adaption circuit according to the invention that is implemented in the control system of FIG. 1.

In FIG. 1, a system 10 is shown that comprises a control system 12 for an electrical machine 14 that is powered via an inverter 16 located between the electrical machine 14 and the control system 12.

The control system 12 is generally configured to control the individual power switches of the inverter 16 in order to control the electrical machine 14, e.g. powering of the individual windings of the electrical machine 14. The controlling is based on different set-points, particularly voltage set-points and current set-points.

The control system 12 comprises a current set-point determination module 18 that has at least one input 20 via which the current set-point determination module 18 receives information of a torque, information of a speed of the electrical machine 14, information of a temperature of the electrical machine 14 and/or information of a DC-link voltage.

The current set-point determination module 18 may process these different kinds of information in order to determine a current set-point that is outputted via an output 22. The processing may be based on a maximum torque per ampere (MTPA) or maximum torque per flux (MTPF) implementation.

The control system 12 further comprises a current controller 24 that is connected to a current set-point determination module 18. The current controller 24 receives the current set-point by a input 26 that is connected with the output 22 of the current set-point determination module 18.

The current controller 24 is configured to process the current set-point received via the input 26 in order to determine a voltage set-point that is outputted via an output 28. The voltage set-point may be determined based on the current set-point and information concerning an angle of the electrical machine 14 as will be described later in more detail.

The voltage set-point outputted by the current controller 24 via its output 28 is forwarded to a voltage modulation module 30 that processes the voltage set-point, thereby determining duty cycles for the different power switches of the inverter 16. The operation of the electrical machine 14 is controlled accordingly.

The control system 12 further comprises a current evaluation module 32 configured to measure current values, particularly alternate current (AC) values outputted by the inverter 16 that are forwarded to the electrical machine 14 for operation purposes, particularly the windings of the electrical machine 14.

In addition, the control system 12 comprises an angle evaluation module 34 that is configured to determine an angle value of the electrical machine 14, particularly its rotor.

The angle evaluation module 34 may be an angle sensor that measures the actual angle of the electrical machine 14. Alternatively, the angle evaluation module 34 is an angle observer that estimates an actual angle of the electrical machine 14.

The angle evaluation module 34 determines the angle value based on a position information measured or estimated to which a corrective value 35 is added. The angle value is then better corresponding to the actual position of the rotor. The corrective value 35 is aligning the angle value from the position sensor with the magnetic d-axis from the motor correcting mechanical (and electrical) angle shifts. An example of determination of the angle value is describe in the patent EP3857704 of which the content is incorporated by reference.

In any case, an angle value is obtained by the angle evaluation module 34 that corresponds to the actual angle value of the electrical machine 14. Hence, an actual offset can be derived from the angle value determined.

Furthermore, the control system 12 comprises an angle adaption circuit 36 that is an add-on circuit. The angle adaption circuit 36 can be used for extending an already existing control system, namely a control system that comprises the respective components described above.

The angle adaption circuit 36 has an input 38 via which the angle adaption circuit 36 receives information of a torque, information of a speed of the electrical machine 14, information of a DC-link voltage and/or information of a temperature of the electrical machine 14, particularly the temperature of a permanent magnet of the electrical machine 14. As shown in FIG. 1, the angle adaption circuit 36 may receive information of an estimated actual torque and information of an input torque set-point.

Generally, the angle adaption circuit 36 is enabled to process the inputted information in order to determine an angle offset outputted via its output 40, wherein the angle offset is applied to the angle value of the electrical machine 14 that is outputted by the angle evaluation module 34.

As shown in FIG. 1, the control system 12 comprises a node 42 that processes both the angle value outputted by the angle evaluation module 34 and the angle offset outputted by the angle adaption circuit 36. Particularly, the angle offset is added to the angle value.

Hence, the angle value determined is shifted due to the angle offset added, thereby obtaining a shifted angle (value).

The shifted angle (value) is forwarded to the current controller 24, particularly a feedback input 44.

The current controller 24 also processes the shifted angle (value) in order to determine the voltage set-point.

Accordingly, the voltage set-point is determined by the current controller 24 based on the shifted angle (value) obtained by the angle evaluation module 34 and the angle adaption circuit 36 that outputs the angle offset that is applied to the angle value of the electrical machine 14. Hence, the operation point of the electrical machine 14 is actively shifted due to the angle offset adaption, thereby optimizing the operation of the electrical machine 14, particularly for low torques and/or low and medium speeds.

The control system 12 further comprises a transformation module 45, e.g. a Park-Clarke transformation module, also called d/q transformation module.

The transformation module 45 processes the shifted angle value and a current information outputted by the current evaluation module 32, particularly a phase current value, in order to provide actual current values in a different coordinate system, e.g. a coordinate system based on two axes, namely d and q.

These current values are forwarded to the current controller 24 that also processes this information in order to determine the voltage set-point outputted by its output 28.

In FIG. 2, the angle adaption circuit 36 is shown in more detail.

The angle adaption circuit 36 comprises an adaption module 46 that processes the information received via the at least one input 38 and to output via the output 40 the angle offset that is applied to the angle value of the electrical machine 14, thereby obtaining an angle adaption.

The adaption module 46 comprises a look-up table 47 that processes information of the torque, particularly the estimated torque, and information of the speed of the electrical machine 14.

Based on this information, the look-up table 46 outputs a pre-adapted angle offset (“gamma_angle_adaption_unfilt”) that is further processed by a filter module 48 in order to obtain the angle offset (“gamma_angle_adaption”) that is used for angle adaption.

Accordingly, the look-up table 47 links the information received via the input 38 with an angle offset, particularly the pre-adapted angle offset.

In addition, FIG. 2 shows that the pre-adapted angle offset is obtained by processing information of the temperature of the electrical machine 14, particularly a rotor temperature and/or a permanent magnet temperature, as well as information of a DC-link voltage.

The angle adaption circuit 36 comprises a state determination module 50 that receives the information of the speed of the electrical machine 14, the information of the temperature of the electrical machine 14 and the information of the DC-link voltage based on which the respective state is determined, e.g. a MTPA/MTPV state. The respective state may correspond to “0” or “1”, thereby ensuring that the angle adaption only takes place in certain operation point ranges.

The determined state as well as the temperature information obtained are further processed by components 52, 54, 56, particularly multipliers.

In general, the angle adaption circuit 36 outputs an angle offset that is applied to the angle value determined for the electrical machine 14, particularly the rotor of the electrical machine 14, in order to shift the angle accordingly, thereby obtaining the shifted angle (value). Particularly, an already determined offset of the respective angle is shifted. The shifted angle is processed by the control system 12, namely the current controller 24. Accordingly, the operation point of the electrical machine 14 is actively shifted due to the angle offset adaption in order to optimize the operation of the electrical machine 14 for low torques and/or low and medium speeds.

1. An angle adaption circuit for shifting an angle used by a control system of an electrical machine wherein the angle adaption circuit comprises at least one input for receiving information of a torque and/or information of a speed of the electrical machine wherein the angle adaption circuit comprises an adaption module connected with the at least one input wherein the adaption module is configured to process the information received via the at least one input and to output an angle offset to be applied to an angle value of the electrical machine.

2. The angle adaption circuit according to claim 1, wherein the at least one input is further configured to receive information of a DC-link voltage and/or information of a temperature of the electrical machine particularly the temperature of a permanent magnet of the electrical machine.

3. The angle adaption circuit according to claim 1, wherein the information of the torque corresponds to an estimated actual torque and/or an input torque set-point.

4. The angle adaption circuit according to claim 1, wherein the adaption module comprises a look-up table that links the information received via the at least one input with the angle offset.

5. The angle adaption circuit according to claim 1, wherein the adaption module comprises a filter module that is configured to filter a pre-adapted angle offset, thereby obtaining the angle offset.

6. The angle adaption circuit according to claim 1, wherein the angle adaption circuit is an add-on circuit that is configured to be implemented into a control system for the electrical machine.

7. A control system for an electrical machine the control system comprises a controller an angle evaluation module configured to determine an angle value of the electrical machine and the angle adaption circuit according to claim 1.

8. The control system according to claim 7, wherein the angle evaluation module and the angle adaption circuit are connected with each other in a node that is configured to process the angle value determined by means of the angle evaluation module and the angle offset outputted by means of the angle adaption circuit, thereby determining a shifted angle value.

9. The control system according to claim 8, wherein the node is connected to the controller such that the controller is configured to receive the shifted angle value, thereby shifting the operation point for the electrical machine.

10. The control system according to claim 7, wherein the angle evaluation module is an angle sensor configured to measure an actual angle of the electrical machine or wherein the angle evaluation module is an angle observer configured to estimate an actual angle of the electrical machine.

11. The angle adaption circuit according to claim 2, wherein the information of the torque corresponds to an estimated actual torque and/or an input torque set-point.

12. The angle adaption circuit according to claim 2, wherein the adaption module comprises a look-up table that links the information received via the at least one input with the angle offset.

13. The angle adaption circuit according to claim 2, wherein the adaption module comprises a filter module that is configured to filter a pre-adapted angle offset, thereby obtaining the angle offset.

14. The angle adaption circuit according to claim 2, wherein the angle adaption circuit is an add-on circuit that is configured to be implemented into a control system for the electrical machine.

15. A control system for an electrical machine, the control system comprises a controller, an angle evaluation module configured to determine an angle value of the electrical machine and the angle adaption circuit according to claim 2.

16. The control system according to claim 8, wherein the angle evaluation module is an angle sensor configured to measure an actual angle of the electrical machine or wherein the angle evaluation module is an angle observer configured to estimate an actual angle of the electrical machine.

17. The angle adaption circuit according to claim 3, wherein the adaption module comprises a look-up table that links the information received via the at least one input with the angle offset.

18. The angle adaption circuit according to claim 3, wherein the adaption module comprises a filter module that is configured to filter a pre-adapted angle offset, thereby obtaining the angle offset.

19. The angle adaption circuit according to claim 3, wherein the angle adaption circuit is an add-on circuit that is configured to be implemented into a control system for the electrical machine.

20. A control system for an electrical machine, the control system comprises a controller, an angle evaluation module configured to determine an angle value of the electrical machine and the angle adaption circuit according to claim 3.
